(19) United States
(12) Patent Application Publication
(10) Pub. No.: US 2014/0351109 A1
(43) Pub. Date: Nov. 27, 2014

(54) METHOD AND APPARATUS FOR AUTOMATICALLY IDENTIFYING A FRAUDULENT ORDER

(71) Applicant: Light In The Box Limited, CENTRAL (HK)

(72) Inventor: Kefeng Peng, Beijing (CN)

(73) Assignee: Light In The Box Limited, CENTRAL (HK)

(21) Appl. No.: 13/950,714

(22) Filed: Jul. 25, 2013

(30) Foreign Application Priority Data
May 22, 2013 (CN) 201310192076.4

(51) Int. Cl. G06Q 40/00

(52) U.S. Cl. CPC G06Q 40/00
USPC 705/35

(57) ABSTRACT

A method and apparatus for automatically identifying a fraudulent order are disclosed. The method comprises: a model training phase which comprises: taking history orders, which have been determined as fraudulent or not, as training samples, and extracting characteristics from respective history orders to provide respective characteristic vectors for the history orders; and training an order identifying model using the characteristic vectors for respective history orders, and an order identifying phase which comprises: extracting characteristics from an order to be identified to provide a characteristic vector for the order to be identified, and inputting the characteristic vector for the order to be identified into the order identifying model to obtain therefrom a result of whether the order to be identified is fraudulent or not. The method and apparatus according to the present disclosure are more adaptable to the rapid development of electronic commerce market, and more difficult to break.

### BACKGROUND

1. Technical Field

The present application relates to computer applications, and particularly to a method and apparatus for automatically identifying a fraudulent order.

2. Description of the Related Art

With the robust development of electronic commerce, fraudulent actions become increasingly common. Frauds in electronic payment bring particularly large loss to the clients. Besides, as a result of the increased development of electronic commerce, nationality of a client, means of payment, and commodity, etc. become more and more diversified. Therefore, how to recognize a fraudulent order becomes increasingly important and necessary.

However, pure artificial examination on the orders turns out to be inefficient and expensive, so automatic identification is more commonly used in the art. Two techniques have been generally used in the art for automatically identifying a fraudulent order: one is to maintain a black list; the other is to rely on predefined rules. However, since electronic commerce is rapidly expanding, thousands of new clients are involved in the electronic commerce market every day. A black list is obviously incapable of dealing with such an explosive number of clients. Predefined rules may be maliciously studied and broken, and become invalid eventually. Besides, due to the diversity in the electronic commerce market, those predefined rules have to be constantly modified. Therefore, it can be seen that identification based on predefined rules is manpower consumptive and on the other hand, cannot be used as widely as expected.

### BRIEF SUMMARY

In view of the above, a method and apparatus for automatically identifying a fraudulent order are disclosed, which are more adaptable to the rapid development of electronic commerce market, and more difficult to break.

A method for automatically identifying a fraudulent order is disclosed in one embodiment, comprising:

a model training phase which comprises:

Step S11: taking history orders, which have been determined as fraudulent or not, as training samples, and extracting characteristics from respective history orders to provide respective characteristic vectors for the history orders; and

Step S12: training an order identifying model using the characteristic vectors for respective history orders; and

an order identifying phase which comprises:

Step S21: extracting characteristics from an order to be identified to provide a characteristic vector for the order to be identified, and

Step S22: inputting the characteristic vector for the order to be identified into the order identifying model to obtain therefrom a result of whether the order to be identified is fraudulent or not.

In an embodiment, the characteristics to be extracted from the orders in the aforesaid Steps S11 and S21 include at least one of: information directly included in an order, history actions of a client that places an order in an electronic commerce system, and information on the Internet available via client data.

According to an embodiment of the present disclosure, the information directly included in an order comprises at least one of: client data, order language, order amount, means of payment, and information with respect to commodity. The history actions of a client that places an order in an electronic commerce system comprise at least one of: how long a client browses a shopping website, how many times the client browses the shopping website, and shopping experiences. The information on the Internet available via client data comprises at least one of: whether a person is real or how many fans a person has upon inquiry into a social website with API, and whether a client address is real upon an inquiry into an electronic map with API.

According to an embodiment of the present disclosure, the order identifying phase further comprises:

Step S23: if the order to be identified is determined as fraudulent, generating a readable description for artificial examination based on the characteristic vector for the order to be identified.

According to an embodiment, generating a readable description based on the characteristic vector for the order to be identified comprises: generating a readable description based on characteristics of the order to be identified, which have an information gain greater than a first predefined gain threshold with respect to the result of whether the order to be identified is fraudulent or not.

According to an embodiment of the present disclosure, the model training phase comprises: determining whether a new combination of characteristics has an information gain greater than a second predefined gain threshold with respect to the result of whether the order to be identified is fraudulent or not; and if positive, determining that the new combination of characteristics enhances the order identifying model and grouping the new combination of characteristics into the characteristics of orders extracted during the model training phase and the order identifying phase.

According to an embodiment of the present disclosure, the information gain is computed using the following Equations:

gain(A)=info(D₁)−info_{A}(D₁)

where D₁ denotes a fraudulent order; gain(A) denotes information gain of a characteristic or a combination of characteristics A with respect to the result of whether the order to be identified is fraudulent or not; info(D₁) denotes an entropy of the result of whether the order to be identified is fraudulent or not; and info_{A} (D₁) denotes information expected from the characteristic or the combination of characteristics A with respect to the result of whether the order to be identified is fraudulent or not;

$$info ( {D}_{j} ) - {\sum }_{i = 1}^{m} {p}_{ij} {log}_{2} ( {p}_{ij} )$$

where pᵢⱼ denotes the probability of Characteristic i occurring in Type Dⱼ history orders in the training sample; m denotes the number of characteristics; j equals to 0 or 1; and D₀ denotes a non-fraudulent order; and

$${info}_{A} ( D ) = {\sum }_{j = 0}^{1} \frac{\vert {D}_{j} \vert}{\vert D \vert} info ( {D}_{j} )$$

where |Dⱼ| denotes the number of Type Dⱼ history orders in the training sample; and |D| denotes the total number of history orders included in the training sample.

In another embodiment of the present disclosure, an apparatus for automatically identifying a fraudulent order is disclosed, comprising:

a model training unit which comprises:

an offline characteristic extracting subunit configured to take history orders, which have been recognized as fraudulent or not, as training samples, and to extract characteristics from respective history orders to provide respective characteristic vectors for the history orders; and

a model training subunit configured to train an order identifying model using the characteristic vectors for respective history orders; and

an order identifying unit which comprises:

an online characteristic extracting subunit configured to extract characteristics from an order to be identified to provide a characteristic vector for the order to be identified; and

an order identifying subunit configured to input the characteristic vector for the order to be identified into the order identifying model to obtain therefrom a result of whether the order to be identified is fraudulent or not.

According to an embodiment of the present disclosure, the characteristics to be extracted from the orders by the offline characteristic extracting subunit and the online characteristic extracting subunit include at least one of: information directly included in an order, history actions of a client that places an order in an electronic commerce system, and information on the Internet available via client data.

According to an embodiment of the present disclosure, the information directly included in an order comprises at least one of: client data, order language, order amount, means of payment, and information with respect to commodity. The history actions of a client that places an order in an electronic commerce system comprise at least one of: how long the client browses a shopping website, how many times the client browses the shopping website, and shopping experiences. The information on the Internet available via client data comprises at least one of: whether a person is real or how many fans a person has upon inquiry into a social website with API, and whether a client address is real upon an inquiry into an electronic map with API.

According to an embodiment of the present disclosure, the order identifying unit further comprises: a readable description generating subunit, configured to generate, if the order to be identified is determined as fraudulent, a readable description for artificial examination based on the characteristic vector for the order to be identified.

According to an embodiment, when generating a readable description, the readable description generating subunit generates the readable description based on characteristics of the order to be identified, which have an information gain greater than a first predefined gain threshold with respect to the result of whether the order to be identified is fraudulent or not.

According to an embodiment of the present disclosure, the model training unit further comprises a determination subunit, configured to determine whether a new combination of characteristics has an information gain greater than a second predefined gain threshold with respect to the result of whether the order to be identified is fraudulent or not; and, if positive, determine that the new combination of characteristics enhances the order identifying model, and group the new combination of characteristics into the characteristics of orders extracted during the model training phase and the order identifying phase.

According to an embodiment of the present disclosure, the information gain is computed using the following Equations:

gain(A)=info(D₁)−info_{A}(D₁)

where D₁ denotes a fraudulent order; gain(A) denotes information gain of a characteristic or a combination of characteristics A with respect to the result of whether the order to be identified is fraudulent or not; info(D₁) denotes an entropy of the result of whether the order to be identified is fraudulent or not; and info_{A}(D₁) denotes information expected from the characteristic or the combination of characteristics A with respect to the result of whether the order to be identified is fraudulent or not;

$$info ( {D}_{j} ) - {\sum }_{i = 1}^{m} {p}_{ij} {log}_{2} ( {p}_{ij} )$$

where pᵢⱼ denotes the probability of Characteristic i occurring in Type Dⱼ history orders in the training sample; m denotes the number of characteristics; j equals to 0 or 1; and D₀ denotes a non-fraudulent order; and

$${info}_{A} ( D ) = {\sum }_{j = 0}^{1} \frac{\vert {D}_{j} \vert}{\vert D \vert} info ( {D}_{j} )$$

where |Dⱼ| denotes the number of Type Dⱼ history orders in the training sample; and |D| denotes the total number of history orders included in the training sample.

In view of the above, the method and apparatus disclosed in the present disclosure train an order identifying model according to characteristics of history orders, and applies the established order identifying model for automatically identifying a fraudulent order. The techniques of the present disclosure can learn characteristics of a fraudulent order occurring in an electronic commerce system fast, such that they are more adaptable to the ever-expanding electronic commerce market, and more difficult to break as compared with the techniques based on predefined rules.

### BRIEF DESCRIPTION OF THE DRAWINGS

FIG. 1 is a flow chart of a method for automatically identifying a fraudulent order according to a first embodiment of the present disclosure.

FIG. 2 is a schematic diagram of an apparatus for automatically identifying a fraudulent order according to a second embodiment of the present disclosure.

### DETAILED DESCRIPTION

The objects, technical solutions and merits of the present disclosure will be more apparent from the following detailed description of embodiments with reference to the drawings.

The invention is mainly implemented in two phases: a model training phase and an order identifying phase. In the model training phase, history orders which have been identified as fraudulent or not are taken as samples for training an order identifying model. In the order identifying phase, the order identifying model which has been established in the model training phase is used to examine an order to be identified to eventually determine whether this order is fraudulent or not. Hereunder a first embodiment regarding the method as disclosed will be disclosed in greater details.

### Embodiment 1

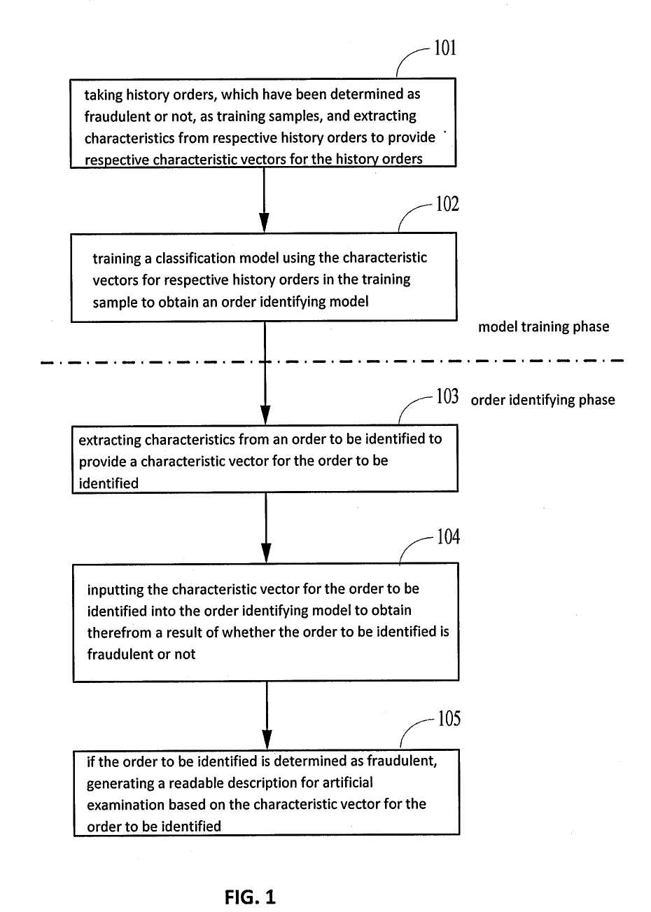

FIG. 1 illustrates a flow chart of a method for automatically identifying a fraudulent order according to a first embodiment of the present disclosure. As shown in FIG. 1, the method comprises the following steps:

Step 101: taking history orders, which have been recognized as fraudulent or not, as training samples, and extracting characteristics from respective history orders to provide respective characteristic vectors for the history orders.

History orders which have been determined as fraudulent or not are first organized into training samples. The characteristics to be extracted comprise at least one group of the following:

The first group comprises information directly included in the history orders, which comprises, but is not limited to, one or any combinations of client data (including name, address, mailbox and telephone number, etc. of the client), order language, order amount, means of payment, and information with respect to the commodity (including the name and classification of the commodity).

Each order has an ID, based on which the information of the aforesaid first group may be looked up in an order database. The information directly included in an order, a direct reflection of the order to be identified, may directly tell whether an order is fraudulent or not.

The second group includes history actions of a client that places an order in an electronic commerce system, which includes, but is not limited to, one or any combinations of how long the client browses a shopping website, how many times the client browses the shopping website, and shopping experiences.

Using the client ID, the history actions of a client in the electronic commerce system may be located from the database of the client history actions. Although the history actions of a client only indirectly tell whether an order is fraudulent or not, they still play an important role in identifying a fraudulent order. For example, a normal client generally reads commodity information presented on a shopping website carefully before purchasing, and places an order only after serious consideration and price compare. In other words, those orders that are placed by a client without even browsing a shopping website are more likely to be fraudulent, while those placed by regular clients who have multiple successful shopping experiences with the shopping website are less likely to be fraudulent.

The third group comprises information on the Internet available via client data, which includes, but is not limited to, one or any combinations of: whether a person is real or how many fans a person has upon inquiry into a social website with API, and whether a client address is real upon inquiry into an electronic map with API.

Generally speaking, those who shop over an electronic commerce system tend to be a frequenter to the Internet, and therefore would be more likely to use a social website. Therefore, inquiring a social website helps verify a real client. However, given a great number of fake accounts of a social website, whether a client is real may be further confirmed based on the number of fans he or she has in that social website. This is evaluation with respect to a client's identity. Further, whether a client address is real may be determined by looking up that address in an electronic map. A social website and an electronic map website, etc. usually offers APIs, and some offers them unconditionally, typically the electronic map. Therefore, it is possible to verify a client address by looking it up in an electronic map with an API. A social website generally offers the API with the proviso that only registered users are allowed to visit. Consequently, whether a person is real or how many fans he or she has may be learnt by inquiring into a social website with API. This inquiry may be completed by registering with or closing a deal with that social website.

Take the following history order as an example: client nationality: Italy; order language: English; order amount: 200$; means of payment: PayPal; commodity category: mobile phones; the client browses the shopping website four times, totaling 90 minutes; has two shopping experiences; owns a Facebook account; has 200 fans in Facebook; and the client address is real. The history order in issue then consists of the following vectors: (Italy; English; 200$; PayPal; mobile phones; browsing 4 times for 90 minutes; two shopping experiences; a Facebook account; 200 fans; real address).

Step 102: training an order identifying model using the characteristic vectors for respective history orders in the training sample

The order identifying model of the present disclosure may comprise a classification model, for example, a Support Vector Machine (SVM) model and a Maximum Entropy Model. The trained order identifying model comes to a result of whether an order is fraudulent or not.

One of the characteristics extracted in the aforesaid Step 101 may be sufficient to identify a fraudulent order. For example, an order may be deemed as a fraud if a client address is found unreal by looking it up in an electronic map based on API, or if a client does not even browse a shopping website. Alternatively, a combination of several characteristics is used to locate a fraudulent order. For example, the client's nationality does not agree with the language he uses in the order; or the commodity information does not match with the order amount; or although a client browses a shopping website for multiple times, he or she has zero shopping experience, or does not exist upon inquiry into a social website based on API, etc. Therefore, when extracting characteristics to form a characteristic vector, it is preferable that the characteristic vector comprises more than one characteristic, such that the result produced by the trained order identifying model is more accurate.

The foregoing Steps 101 and 102 constitute a model training phase, which may be executed periodically after a certain time interval. After that time interval, new orders may be completed, and will be included in the training sample as history orders for intensive model training. These new history orders may be artificially examined after having been inputted into the trained order identifying model, such that the newly trained order identifying model will have an increased accuracy. The steps to be introduced below constitute an order identifying phase, in which orders are examined to identify fraudulent orders. The orders to be identified may be new orders a client places over an electronic commerce system, for example, a paid order that the system newly generates and needs to be examined for the client's reference so as to reduce the risk run by the client.

Step 103: extracting characteristics from an order to be identified to form a characteristic vector specific for the order to be identified.

In this step, the characteristics need to be extracted from the order to be identified in the same manner as in the aforesaid first phase of training an order identifying model. That is, the same characteristics as those extracted in the first phase need to be extracted for the order to be identified in this step, and meanwhile arranged in the same sequence to form a characteristic vector as well.

Step 104: inputting the characteristic vector for the order to be identified into the order identifying model to obtain therefrom a result of whether the order to be identified is fraudulent or not.

After inputting the characteristic vector for the order to be identified into the order identifying model, the order identifying model will classify the order to be identified into a fraudulent order or a non-fraudulent order. The classification produces the identification result.

Step 105: if the order to be identified is recognized as fraudulent, a readable description will be generated for artificial examination based on the characteristic vector for the identified order.

If the order identifying model determines a fraudulent order, the determined result may be further subjected to artificial verification. To facilitate the artificial verification, a readable description may be generated based on the characteristic vector specific for the order to be identified, and then presented before the examiner. When generating the readable description, all of the characteristics included in the characteristic vector for the order to be identified may be taken into account. However, in one embodiment, to facilitate the examiner's verification on key information, the readable description is generated based on those characteristics in the characteristic vector that have greater impact on the identifying result.

The characteristics that have greater impact may be those that have an information gain greater than a first gain threshold with respect to the identifying result. Information gains of various characteristics may be computed using the following Equations:

Information gain (A) of Characteristic A with respect to the order identifying result is determined as:

gain(A)=info(D₁)−info_{A}(D₁) (1)

where D₁ denotes a fraudulent order; info(D₁) denotes an entropy of the order identifying result; and info_{A}(D₁) denotes information expected from Characteristics A with respect to the order identifying result. In particular

$$info ( {D}_{j} ) - {\sum }_{i = 1}^{m} {p}_{ij} {log}_{2} ( {p}_{ij} ) \qquad ( 2 )$$

where pᵢⱼ denotes the probability of Characteristic i occurring in Type Dⱼ history orders in the training sample; m denotes the number of characteristics; j equals to 0 or 1; and D₀ denotes a non-fraudulent order. In particular, the probability of Characteristic i occurring in Type Dⱼ history orders in the training sample is computed as the ratio of the times that Characteristic i occurs in Type Dⱼ history orders in the training sample to the number of Type Dⱼ history orders in the training sample |Dⱼ|.

$${info}_{A} ( D ) = {\sum }_{j = 0}^{1} \frac{\vert {D}_{j} \vert}{\vert D \vert} info ( {D}_{j} ) \qquad ( 3 )$$

where |D| denotes the total number of history orders included in the training sample.

Assuming that a client of a history order to be identified comes from Italy but uses English in the order, it is found, upon computation, that the information gains of these two characteristics with respect to the order identifying result are greater than the predefined information gain threshold. In that case, these two characteristics are considered as key information to a fraudulent order, and may be used to generate a readable description, which may read, for example, “the client comes from Italy and uses English; this order is suspected as a fraudulent order”. Given this description, the responsible examiner may conveniently review important information of this order, and quickly come to a result.

Once an order to be identified is eventually confirmed as fraud, it may be grouped into a history order database, and thereafter introduced in the training sample as a history order for training an order identifying model. Consequently, the established order identifying model will have an increased accuracy. On the other hand, with the development of electronic commerce system, characteristics of new fraudulent orders may gradually be learnt by the order identifying model.

In addition, new characteristics of a fraudulent order may be studied and examined by human in combination with machine. For example, some characteristics may seem irrelevant to a fraudulent order individually, but will show a certain connection when combined. Taking the same example as illustrated above. Characteristics “the client comes from Italy” and “the client uses English in the order”, when combined, may suggest a possible fraudulent order. If the like combinations of characteristics are leant by human with the aid of machine, they may be included in the order identifying model for enhancing the model.

When evaluating a new combination of characteristics, whether the new combination enhances the order identifying model may be determined by judging whether this new combination of characteristics, when added to the existing characteristics, has an information gain greater than a second predefined gain threshold with respect to the identification result. If positive, the new combination of characteristics is determined to enhance the order identifying model, and will be introduced into the order identifying model, i.e., into the characteristics extracted from the orders during the model establishing phase and the order extracting phase. Likewise, the information gain of a combination of characteristics may be also determined using the foregoing Equations (1) through (3). The only difference is that in this case, a combination of characteristics is regarded as Characteristic A in the foregoing Equations (1) through (3).

Hereinabove is a detailed description to the method disclosed in the present disclosure. An apparatus according to a second embodiment of the present disclosure will be introduced in details hereunder.

### Embodiment 2

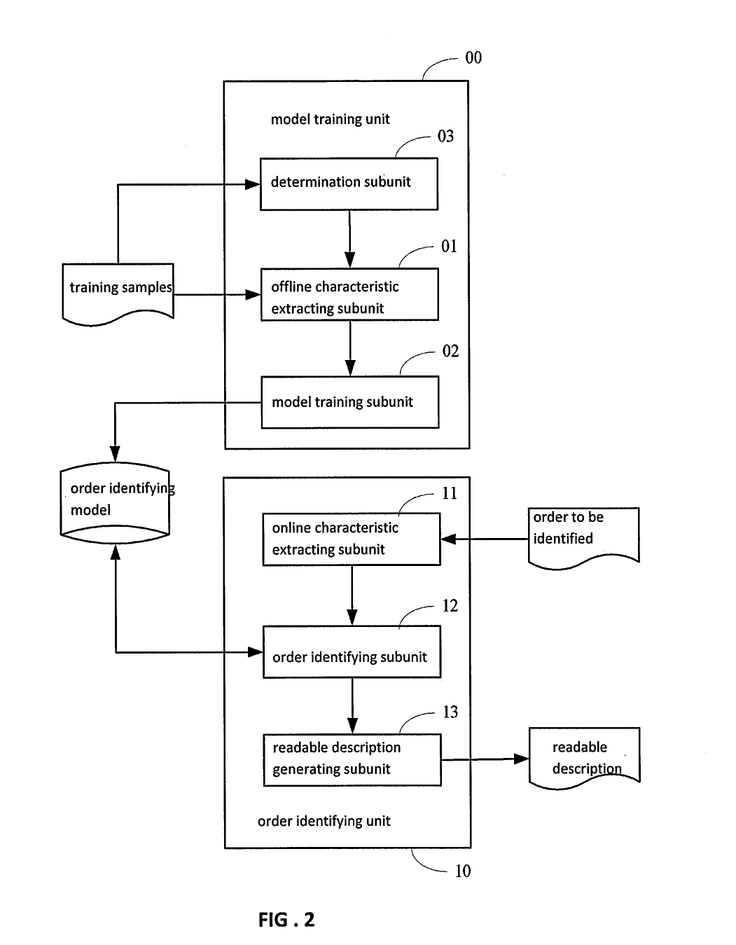

FIG. 2 is a structural diagram of an apparatus for automatically identifying a fraudulent order according to a second embodiment. This apparatus is arranged in an electronic commerce system for automatically identifying a fraudulent order. As shown in FIG. 2, the apparatus comprises a model training unit 00 and an order identifying unit 10.

The model training unit 00 is configured to perform offline training on an order identifying model, which comprises: an offline characteristic extracting subunit 01 and a model training subunit 02. The offline characteristic extracting subunit 01 takes the history orders which have been identified as fraudulent or not as training samples, and extract characteristics from various history orders to form respective characteristic vectors for the history orders.

Characteristics to be extracted by the offline characteristic extracting subunit 01 from history orders may include at least one of: information directly included in an order, history actions of a client that places an order in an electronic commerce system, and information on the Internet available via client data.

In particular, the information directly included in an order comprises at least one of: client data, order language, order amount, means of payment, and information with respect to commodity. The history action of a client that places an order in an electronic commerce system comprises at least one of: how long the client browses a shopping website, how many times the client browses the shopping website, and shopping experiences. The information on the Internet available via client data comprises at least one of: whether a person is real or how many fans a person has upon inquiry into a social website with API, and whether a client address is real upon an inquiry into an electronic map with API.

Subsequently, a model training subunit trains an order identifying model based on characteristic vectors of various history orders. The order identifying model in the sense of the present disclosure may comprise, for example, a Support Vector Machine (SVM) model and a Maximum Entropy Model. The trained order identifying model produces a result of whether an order is fraudulent or not.

The foregoing model training unit 00 may execute model training periodically after a certain time interval. After a certain time interval, new orders may be completed, and will be included in the training sample as history orders for intensive model training. These new history orders may be further subjected to artificial examination after having been inputted into the trained order identifying model, such that the newly trained order identifying model will have an increased accuracy.

The order identifying unit 10 may comprise: an online characteristic extracting subunit 11 and an order identifying subunit 12. For an order to be identified in an electronic commerce system, the online characteristic extracting subunit 11 extracts characteristics related to the order to be identified to form a characteristic vector specific for that order. The characteristics of the order to be identified need to be extracted in the same manner as those extracted by the offline characteristic extracting unit 01. That is, the same characteristics should be extracted for the order to be identified as those extracted in the model training phase, and meanwhile arranged in the same sequence to form the characteristics vector.

Then the order identifying subunit 12 inputs the characteristic vector specific for the order to be identified into the order identifying model to obtain a result of whether the order to be identified is fraudulent or not.

The order identifying unit 10 may further comprise: a readable description generating subunit 13, configured to generate, if the order to be identified is determined as fraudulent by the order identifying subunit 12, a readable description for artificial examination based on the characteristic vector for the order to be identified.

To facilitate artificial verification, the readable description generating subunit 13 may generate the readable description using only those characteristics in the characteristic vector, which have an information gain greater than a first predefined gain threshold with respect to the order identifying result.

The information gain of a characteristic may be computed using the same Equations (1) through (3) presented the foregoing embodiment 1, and is not described again here.

Further, new characteristics of a fraudulent order may be studied and examined by human with the aid of machine, such that the characteristics of new fraudulent orders may be gradually leant and recognized by the order identifying model. In view of this, the model training unit 00 may further comprise: a determination subunit 03 configured to determine whether a new combination of characteristics has an information gain greater than a second predefined gain threshold with respect to the result of whether the order to be identified is fraudulent or not; and, if positive, determine that the new combination of characteristics enhances the order identifying model, and group the new combination of characteristics into the characteristics of orders extracted during the model training phase and the order identifying phase. The information gain of the combined characteristics is still computed using the aforesaid Equations (1) through (3). The only difference is that in this case, the combination of characteristics is regarded as Characteristic A in the foregoing Equations (1) through (3).

In view of above, the method and apparatus according to the present disclosure have the following advantages:

1) The method and apparatus as disclosed quickly learn characteristics of a fraudulent order from history orders for automatic identification. Consequently, new characteristics associated with a fraudulent order that continue to emerge in an electronic commerce market may be learnt fast, such that the present invention may be more adaptable to the increasingly expanded electronic commerce market.

2) The method and apparatus as disclosed do not rely on fixed predetermined rules, but are based on a machine readable model, thereby increasing the difficulty to break.

3) Since the orders that have been identified or artificially reviewed may be taken as history orders in the training of the order identifying model, and since new characteristics that have greater significance to the identification of fraudulent order may be introduced, when evaluated, into the existing characteristics that need to be extracted for order identification, the order identifying model may have an increased accuracy and wider use.

Persons skilled in the art would appreciate that the method and apparatus according to the present disclosure may be implemented in different embodiments than those introduced above. Therefore, the aforesaid apparatus embodiment should be considered illustrative only. For example, the aforesaid units are simply classified according to the logical functions, and may be classified in a different manner when executed. Further, various functional units disclosed in each of the embodiments may be integrated into the same unit, or exist as individual physical units, or two or more of such functional units are integrated into the same unit. These integrated units may be implemented as hardware or a combination of hardware and software functional units.

The integrated units, if implemented as software functional units as above, may be stored on a computer readable medium including a number of instructions that enable a computing device (including a PC, server, or network device), or a processor to execute part of the steps of the methods disclosed in various embodiments hereinabove. The aforesaid storage medium includes various mediums that may store program codes, such as a U-disk, a mobile hard disk, a read-only memory (ROM), a random Access Memory (RAM), a magnetic disk or an optical disk.

The aforesaid embodiments should be considered illustrative only rather than limiting the scope of the present disclosure. Therefore, any equivalent substitutions or variations to the claim characteristics made within the sprit and principle of the present disclosure should be considered as part of the present disclosure.

1. A method for automatically identifying a fraudulent order, comprising:
a model training phase which comprises:
Step S11: taking history orders, which have been determined as fraudulent or not, as training samples, and extracting characteristics from respective history orders to provide respective characteristic vectors for the history orders; and
Step S12: training an order identifying model using the characteristic vectors for respective history orders; and
an order identifying phase which comprises:
Step S21: extracting characteristics from an order to be identified to provide a characteristic vector for the order to be identified, and
Step S22: inputting the characteristic vector for the order to be identified into the order identifying model to obtain therefrom a result of whether the order to be identified is fraudulent or not.

2. The method according to claim 1, wherein the characteristics to be extracted from the orders in said Steps S11 and S21 include at least one of: information directly included in an order, history actions of a client that places an order in an electronic commerce system, and information on the Internet available via client data.

3. The method according to claim 2, wherein the information directly included in an order comprises at least one of: client data, order language, order amount, means of payment, and information with respect to commodity;
wherein the history actions of a client that places an order in an electronic commerce system comprise at least one of: how long the client browses a shopping website, how many times the client browses the shopping website, and shopping experiences; and
wherein the information on the Internet available via client data comprises at least one of: whether a person is real or how many fans a person has upon inquiry into a social website with API, and whether a client address is real upon an inquiry into an electronic map with API.

4. The method according to claim 1, wherein the order identifying phase further comprises:
Step S23: if the order to be identified is determined as fraudulent, generating a readable description for artificial examination based on the characteristic vector for the order to be identified.

5. The method according to claim 4, wherein generating a readable description based on the characteristic vector for the order to be identified comprises: generating a readable description based on characteristics of the order to be identified, which have an information gain greater than a first predefined gain threshold with respect to the result of whether the order to be identified is fraudulent or not.

6. The method according to claim 1, wherein the model training phase further comprises:
determining whether a new combination of characteristics has an information gain greater than a second predefined gain threshold with respect to the result of whether the order to be identified is fraudulent or not; and
if positive, determining that the new combination of characteristics enhances the order identifying model, and grouping the new combination of characteristics into the characteristics of orders extracted during the model training phase and the order identifying phase.

7. The method according to claim 5, wherein the information gain is computed using the following Equations:
gain(A)=info(D₁)−info_{A}(D₁) (1)
where D₁ denotes a fraudulent order; gain(A) denotes information gain of a characteristic or a combination of characteristics A with respect to the result of whether the order to be identified is fraudulent or not; info(D₁) denotes an entropy of the result of whether the order to be identified is fraudulent or not; and info_{A}(D) denotes information expected from the characteristic or the combination of characteristics A with respect to the result of whether the order to be identified is fraudulent or not;
$$info ( {D}_{j} ) - {\sum }_{i = 1}^{m} {p}_{ij} {log}_{2} ( {p}_{ij} ) \qquad ( 2 )$$
where pᵢⱼ denotes the probability of Characteristic i occurring in Type Dⱼ history orders in the training sample; m denotes the number of characteristics; j equals to 0 or 1; and D₀ denotes a non-fraudulent order; and
$${info}_{A} ( D ) = {\sum }_{j = 0}^{1} \frac{\vert {D}_{j} \vert}{\vert D \vert} info ( {D}_{j} ) \qquad ( 3 )$$
where |Dⱼ| denotes the number of Type Dⱼ history orders in the training sample; and |D| denotes the total number of history orders included in the training sample.

8. An apparatus for automatically identifying a fraudulent order, comprising:
a model training unit which comprises:
an offline characteristic extracting subunit configured to take history orders, which have been recognized as fraudulent or not, as training samples, and to extract characteristics from respective history orders to provide respective characteristic vectors for the history orders; and
a model training subunit configured to train an order identifying model using the characteristic vectors for respective history orders; and
an order identifying unit which comprises:
an online characteristic extracting subunit configured to extract characteristics from an order to be identified to provide a characteristic vector for the order to be identified; and
an order identifying subunit configured to input the characteristic vector for the order to be identified into the order identifying model to obtain therefrom a result of whether the order to be identified is fraudulent or not.

9. The apparatus according to claim 8, wherein the characteristics to be extracted from the orders by the offline characteristic extracting subunit and the online characteristic extracting subunit include at least one of: information directly included in an order, history actions of a client that places an order in an electronic commerce system, and information on the Internet available via client data.

10. The apparatus according to claim 9, wherein the information directly included in an order comprises at least one of: client data, order language, order amount, means of payment, and information with respect to commodity; the history actions of a client that places an order in an electronic commerce system comprise at least one of: how long the client browses a shopping website, how many times the client browses the shopping website, and shopping experiences; and the information on the Internet available via client data comprises at least one of: whether a person is real or how many fans a person has upon inquiry into a social website with API, and whether a client address is real upon an inquiry into an electronic map with API.

11. The apparatus according to claim 8, wherein the order identifying unit further comprises: a readable description generating subunit, configured to generate, if the order to be identified is determined as fraudulent, a readable description for artificial examination based on the characteristic vector for the order to be identified.

12. The apparatus according to claim 11, wherein when generating a readable description, the readable description generating subunit generates the readable description based on characteristics of the order to be identified, which have an information gain greater than a first predefined gain threshold with respect to the result of whether the order to be identified is fraudulent or not.

13. The apparatus according to claim 8, wherein the model training unit further comprises a determination subunit, configured to determine whether a new combination of characteristics has an information gain greater than a second predefined gain threshold with respect to the result of whether the order to be identified is fraudulent or not; and, if positive, determine that the new combination of characteristics enhances the order identifying model, and group the new combination of characteristics into the characteristics of orders extracted during the model training phase and the order identifying phase.

14. The apparatus according to claim 12, wherein the information gain is computed using the following Equations:
gain(A)=info(D₁)−info_{A}(D₁) (1)
where D₁ denotes a fraudulent order; gain(A) denotes information gain of a characteristic or a combination of characteristics A with respect to the result of whether the order to be identified is fraudulent or not; info(D₁) denotes an entropy of the result of whether the order to be identified is fraudulent or not; and info_{A}(D₁) denotes information expected from the characteristic or the combination of characteristics A with respect to the result of whether the order to be identified is fraudulent or not;
$$info ( {D}_{j} ) - {\sum }_{i = 1}^{m} {p}_{ij} {log}_{2} ( {p}_{ij} ) \qquad ( 2 )$$
where pᵢⱼ denotes the probability of Characteristic i occurring in Type Dⱼ history orders in the training sample; m denotes the number of characteristics; j equals to 0 or 1; and D₀ denotes a non-fraudulent order; and
$${info}_{A} ( D ) = {\sum }_{j = 0}^{1} \frac{\vert {D}_{j} \vert}{\vert D \vert} info ( {D}_{j} ) \qquad ( 3 )$$
where |Dⱼ| denotes the number of Type Dⱼ history orders in the training sample; and |D| denotes the total number of history orders included in the training sample.

15. A computer-readable medium comprising computer readable instructions for training model and identifying order;
the computer readable instructions for training model comprising: taking history orders, which have been determined as fraudulent or not, as training samples, and extracting characteristics from respective history orders to provide respective characteristic vectors for the history orders; and training an order identifying model using the characteristic vectors for respective history orders;
the computer readable instructions for identifying order comprising: extracting characteristics from an order to be identified to provide a characteristic vector for the order to be identified, and inputting the characteristic vector for the order to be identified into the order identifying model to obtain therefrom a result of whether the order to be identified is fraudulent or not.

16. The method according to claim 6, wherein the information gain is computed using the following Equations:
gain(A)=info(D₁)−info_{A}(D₁) (1)
where D₁ denotes a fraudulent order; gain(A) denotes information gain of a characteristic or a combination of characteristics A with respect to the result of whether the order to be identified is fraudulent or not; info(D₁) denotes an entropy of the result of whether the order to be identified is fraudulent or not; and info_{A}(D₁) denotes information expected from the characteristic or the combination of characteristics A with respect to the result of whether the order to be identified is fraudulent or not;
$$info ( {D}_{j} ) - {\sum }_{i = 1}^{m} {p}_{ij} {log}_{2} ( {p}_{ij} ) \qquad ( 2 )$$
where pᵢⱼ denotes the probability of Characteristic i occurring in Type Dⱼ history orders in the training sample; m denotes the number of characteristics; j equals to 0 or 1; and D₀ denotes a non-fraudulent order; and
$${info}_{A} ( D ) = {\sum }_{j = 0}^{1} \frac{\vert {D}_{j} \vert}{\vert D \vert} info ( {D}_{j} ) \qquad ( 3 )$$
where |Dⱼ| denotes the number of Type Dⱼ history orders in the training sample; and |D| denotes the total number of history orders included in the training sample.

17. The apparatus according to claim 13, wherein the information gain is computed using the following Equations:
gain(A)=info(D₁)−info_{A}(D₁) (1)
where D₁ denotes a fraudulent order; gain(A) denotes information gain of a characteristic or a combination of characteristics A with respect to the result of whether the order to be identified is fraudulent or not; info(D₁) denotes an entropy of the result of whether the order to be identified is fraudulent or not; and info_{A}(D₁) denotes information expected from the characteristic or the combination of characteristics A with respect to the result of whether the order to be identified is fraudulent or not;
$$info ( {D}_{j} ) - {\sum }_{i = 1}^{m} {p}_{ij} {log}_{2} ( {p}_{ij} ) \qquad ( 2 )$$
where pᵢⱼ denotes the probability of Characteristic i occurring in Type Dⱼ history orders in the training sample; m denotes the number of characteristics; j equals to 0 or 1; and D₀ denotes a non-fraudulent order; and
$${info}_{A} ( D ) = {\sum }_{j = 0}^{1} \frac{\vert {D}_{j} \vert}{\vert D \vert} info ( {D}_{j} ) \qquad ( 3 )$$
where |Dⱼ| denotes the number of Type Dⱼ history orders in the training sample; and |D| denotes the total number of history orders included in the training sample.
